(19) United States
(12) Patent Application Publication
(10) Pub. No.: US 2024/0286087 A1
(43) Pub. Date: Aug. 29, 2024

(54) FACILE METHOD FOR PREPARATION OF THIN FILM COMPOSITE (TFC) MEMBRANE WITH BOTH HIGH SELECTIVITY AND WATER PERMEANCE

(71) Applicant: The University of Hong Kong, Hong Kong (CN)

(72) Inventors: Li WANG, Hong Kong (CN); Chuyang TANG, Hong Kong (CN)

(21) Appl. No.: 18/428,803

(22) Filed: Jan. 31, 2024

Related U.S. Application Data
(60) Provisional application No. 63/487,290, filed on Feb. 28, 2023.

(51) Int. Cl. B01D 69/12; B01D 61/02; B01D 71/56; C02F 1/44; C08J 7/04

(52) U.S. Cl. CPC B01D 69/1251; B01D 61/027; B01D 71/56; C02F 1/442; C08J 7/0427; C08J 2377/06; C08J 2477/06

(57) ABSTRACT

A thin film composite nanofiltration (TFC-NF) membrane is produced by forming a dispersion of aramid nanofibers (ANFs) in a water miscible polar organic solvent that is formed into a thin film that is contacted with an aqueous solution of a di- and/or poly-amine. This amine absorbed film has a solution of one or more di-, tri, and/or poly acid chlorides in a water immiscible polar organic solvent poured onto the supported film. Upon removal of residual solutions, optionally the film can be activated, and upon drying the TFC-NF membrane is isolated. The TFC-NF membrane produced by this process is superior in permeability and selectivity for use in water purification by nanofiltration.

### CROSS-REFERENCE TO RELATED APPLICATION

The present application claims the benefit of U.S. Provisional Application Ser. No. 63/487,290, filed Feb. 28, 2023, which is hereby incorporated by reference herein in its entirety, including any figures, tables, or drawings.

### BACKGROUND OF THE INVENTION

Commercial nanofiltration (NF) membranes are used for water purification as the membrane rejects almost all dissolved solutes. With pore sizes below about 2 nm, and, generally with negatively charged surfaces, the membranes cut off uncharged solutes in excess of 200 to 1,000 Da, and are effective at separating dissolved ions. The commercial NF membranes have relatively low water permeability, which results in high energy consumption during water/wastewater treatment.

Thin film composite (TFC) membranes have been developed, particularly to remove heavy metals. These membranes employ a polyamide (PA) layer on a polysulfone or polyether sulfone porous substrate. The polyamide layer is formed on the substrate via an interfacial polymerization (IP) between a di- or polyamine with trimesoyl chloride (TMC) or other di-, tri-, or poly-aromatic acid chloride in hexane or other relatively non-polar solvent. Unfortunately, a relatively low permeation flux has generally suffered. Hence the formation of a high permeance highly selective TFC NF membrane is highly desirable.

### BRIEF SUMMARY OF THE INVENTION

Embodiments are directed to a method for preparing a thin film composite nanofiltration (TFC-NF) membrane by providing a dispersion comprising aramid nanofibers (ANFs) in a water miscible polar organic solvent from which a thin film comprising the ANF is formed. An aqueous solution comprising a di- and/or poly-amine is combined with the thin film resulting in an amine absorbed aramid nanofiber film. An organic solution is provided that comprises a di-, tri, and/or poly acid chloride in a water immiscible polar organic solvent, which is added onto the amine absorbed aramid nanofiber film. After removal of the acid chloride depleted organic solution, drying the TFC of the polyamide (PA) on ANFs forms the TFC-NF membrane. The water miscible polar organic solvent can be, but is not limited to, dimethylsulfoxide (DMSO), 1-Methyl-2-pyrrolidinone (NMP) and dimethylformamide (DMF), forming a thin film can involve spreading a film of a plate with a doctor blade. Forming a thin film can be via an automatic film applicator on a plate, which can be a steel plate or any other plate inert to the dispersion. The dispersion can include a base, such as, but not limited to sodium hydroxide, potassium hydroxide, cesium hydroxide or any combination thereof. The di- and/or poly-amine can be, but not limited to, piperazine (PIP), ethylenediamine, linear or branched polyethyleneimine, or any combination thereof. The acid chloride can be, but is not limited to, trimesoyl chloride (TMC), isophthaloyl chloride, or combinations thereof. The water immiscible organic solvent can be, but is not limited to, dichloromethane (DCM), chloroform (TCM), 1,2-dichloroethane (DCE), 1,1,2-Trichloroethane (TCE), benzene (PhH), fluorobenzene (PhF), 1,2-dichlorobenzene (ODCB), 1,2-difluorobenzene (ODFB), butyl acetate, iso-butyl acetate, ethyl butanoate, or any combination thereof. The TFC of a PA on ANFs can be activated by contacting with the water immiscible organic solvent for at least 12 hours.

An embodiment is directed to a thin film composite nanofiltration (TFC-NF) membrane formed by the method described above, where the TFC-NF membrane is characterized by a homogeneous surface morphology comprising a dense nanobubble morphology with a high actual surface area.

Another embodiment is directed to a method of water purification by passing water through the thin film composite nanofiltration (TFC-NF) membrane.

### BRIEF DESCRIPTION OF THE DRAWINGS

FIG. 1 shows a series of photographs taken over a two-week period during preparation of aramid nanofibers (ANF) dispersion.

FIG. 2A shows a scanning electron microscope (SEM) image of the top surface of a cast ANF network.

FIG. 2B show the rear of the cast ANF network of FIG. 2A.

FIG. 3A is a drawing of the phase inversion of a ANF hydrogel, according to an embodiment.

FIG. 3B shows a drawing of the loading of the AND hydrogel onto a non-woven fabric, according to an embodiment.

FIG. 3C shows an assembly for an interfacial reaction.

FIG. 3D shows the addition of the polar organic solvent solution to the assembly of FIG. 3C using dichloromethane (DCM).

FIG. 3E shows a photograph of a wet thin film composite polyamide (TFC-PA) membrane as formed in the assembly.

FIG. 3F shows a photograph of a dried TFC-PA membrane after critical point drying (CPD).

FIG. 4A shows a Cryo-SEM image of the surface of a PA membrane of Example 1.

FIG. 4B shows a Cryo-SEM image of the cross section of a PA membrane of Example 1.

FIG. 5A shows an SEM image of the surface of the TFC-PA membrane of Example 1.

FIG. 5B shows an atomic force microscope image at one magnification for the surface of the TFC-PA membrane of Example 1.

FIG. 5C shows an atomic force microscope image at a greater second magnification for the surface of the TFC-PA membrane of Example 1.

FIG. 5D shows a transmission electron microscope (TEM) cross-sectional image of the TFC-PA membrane of Example 1.

FIG. 5E shows an SEM image of the surface of the TFC-PA membrane of Example 2.

FIG. 5F shows an atomic force microscope image at one magnification for the surface of the TFC-PA membrane of Example 2.

FIG. 5G shows an atomic force microscope image at a greater second magnification for the surface of the TFC-PA membrane of Example 2.

FIG. 5H shows a TEM cross-sectional image of the TFC-PA membrane of Example 2.

FIG. 6A shows a SEM image of the surface of the TFC-PA membrane of Example 5.

FIG. 6B shows a SEM image of the surface of the TFC-PA membrane of Example 6.

FIG. 6C shows a SEM image of the surface of the TFC-PA membrane of Example 7.

FIG. 6D shows a SEM image of the surface of the TFC-PA membrane of Example 8.

FIG. 6E shows a SEM image of the surface of the TFC-PA membrane of Example 9.

FIG. 6F shows a SEM image of the surface of the TFC-PA membrane of Example 10.

### DETAILED DISCLOSURE OF THE INVENTION

Embodiments of the invention are directed to a method for the formation of a nanofiltration (NF) membrane with significantly enhanced water permeance without the sacrifice of solute rejection. The method involves a polar/polar interfacial polymerization based on an amine reservoir hydrogel to prepare a thin film composite nanofiltration ((TFC-NF) membrane, according to an embodiment, that achieves high permeance and high selectivity.

The method employs a polar solvent, such as, but not limited to dichloromethane (DCM) with strong solvency as the organic phase in the performance of the interfacial polymerization where this solvent is retained for the subsequent activation of the TFC-NF membrane. A polar organic solvent resistant supporting aramid nanofiber (ANF), introduced as a hydrogel, assists the interfacial polymerization and provides a high water storage capacity, according to an embodiment. The resulting TFC-NF membrane, according to an embodiment, has a dense nanobubble morphology with a high actual surface area that results in the TFC-NF membrane having high water permeance, yet exhibits an excellent monovalent/divalent selectivity and excellent solute-solute selectivity. The nanobubbles are at a density of about 100 or more nanobubbles per μm leading to an enhanced surface area, a high actual surface area, where the nanobubble surface with a nanobubble thickness of about 300 nm has a surface area about 16 times or greater than that of the equivalent smooth flat surface. The activated TFC-PA membrane exhibits a homogeneous surface morphology.

Prior art TFC-PA do not employ DCM or other polar solvents that can form immiscible interface with aqueous phase during an interfacial polymerization due to multiple difficulties. The traditional method employs a polysulfone or poly(ether-sulfone) substrate, which readily dissolves in DCM during interfacial polymerization. Polar solvent resistant substrates, such as polyvinylidene fluoride and polyacrylonitrile are hydrophobic, are not used to form a TFC-PA membrane due to their limited storage capacity for the amine monomers employed in the interfacial polymerization.

PA membranes based on a free standing method are not employed with DCM, which being denser than water (1.33 g cm⁻³), requires pouring an aqueous phase amine solution onto the acid chloride, such as TMC, DCM solution. An acceptable PA membrane is not readily collected because of the ultrahigh viscosity of the aqueous phase, for example, (0.89 cp at 25° C.) that is required. Forcing a high-density, low-viscous dichloromethane solution onto the highly viscous aqueous phase unfortunately collapses into the aqueous phase, resulting in an unacceptable inhomogeneous TFC-PA membrane.

The method is performed where a dispersion of an aramid nanofiber (ANF) in a basic dimethyl sulfoxide (DMSO) solution is cast onto a non-porous plate, for example a steel plate, and leveled to a thickness of less than a millimeter. The dispersion film is then submerged in an aqueous solution of a di- or poly-amine monomer to form an amine impregnated ANF hydrogel substrate that is positioned onto and sandwiched between a non-woven fabric. Excess, non-absorbed amine is filtered from the substrate and an appropriate amount of a polar solvent solution of the di- or poly-acid chloride monomer is poured onto the substrate. After the rapid polymerization to a PA on the ANF substrate, the polar solvent is used to activate by additional soaking of the TFC-NF membrane formed.

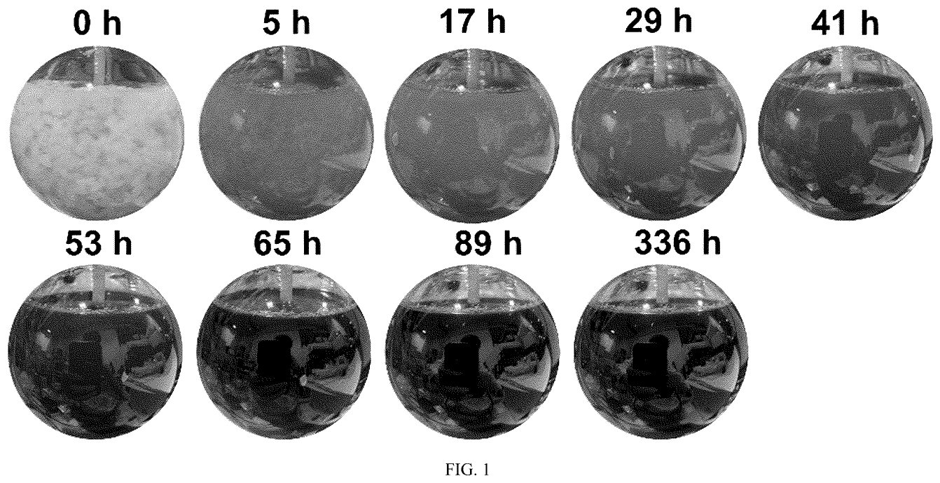

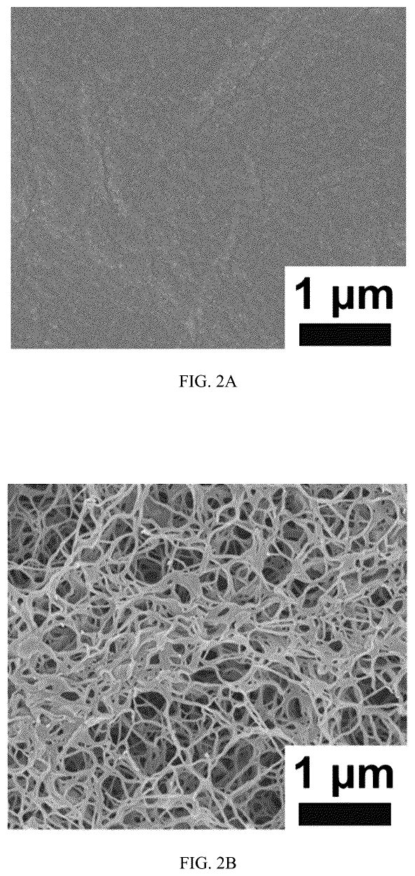

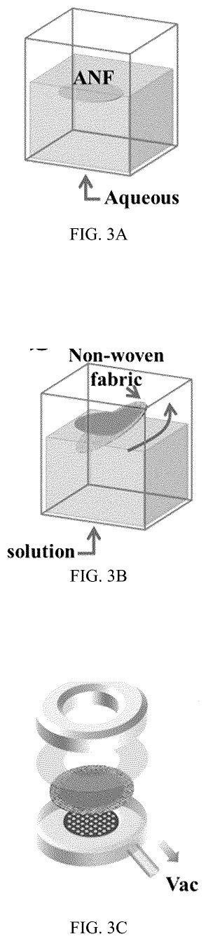

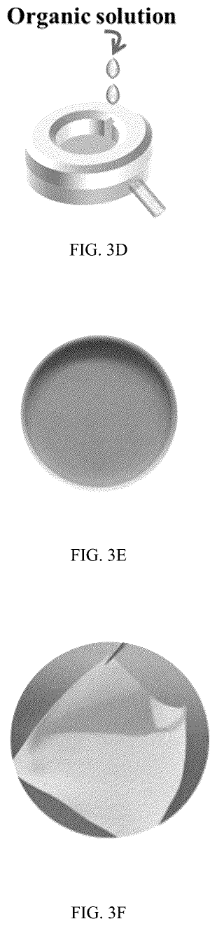

In an exemplary process, about a 1% to about a 3% w/v ANF dispersion stirring in dimethyl sulfoxide (DMSO), as shown in FIG. 1, is prepared by mixing ANF with potassium hydroxide at about a 1% to about 3% w/v using an apparatus that is mechanically sealed from the atmosphere at room temperature for 2˜4 weeks. The resulting ANF dispersion is cast on a steel plate where a doctor blade is used to spread the dispersion into a thickness of about 150˜250 μm and form a ANF hydrogel support that has an asymmetric density from top, FIG. 2A to the bottom, FIG. 2B. The cast ANF support is then submerged into a bath filled with an aqueous solution of piperazine (PIP), as shown in FIB 3A, for a period of about 5 to about 60 minutes to impregnate the ANF and form an amine impregnated hydrogel. The ANF hydrogel is then removed, as shown in FIG. 3B, using a non-woven fabric and sandwiched between a second non-woven fabric layer. The ANF hydrogel, as shown in FIG. 3C, is then supported on surface that is used to vacuum filter excess amine solution from the ANF hydrogel. Subsequently, a solution of trimesoyl chloride (TMC) in dichloromethane (DCM) is poured, as shown in FIG. 3D, onto the ANF hydrogel with a resulting rapid interfacial polymerization of the ANF surface absorbed amine with the acid chloride over about 30 to about 600 seconds. The resulting TFC-NF membrane is optionally, contacted with DCM for an additional about 12 to about 36 hours to activate the TFC-NF membrane. The formed membrane, as shown in FIG. 3E, is then dried to form the final TFC-NF membrane, as shown in FIG. 3F.

This process results in a TFC-PA membrane that has superior flux capacity due to the porous nature of the ANF support and uniformity of the PA deposited on the ANF. The resulting membrane has high rejection of non-ionic solutes and ionic solutes at these superior flux rates. Following are examples that illustrate procedures for practicing the invention. These examples should not be construed as limiting. All percentages are by weight and all solvent mixture proportions are by volume unless otherwise noted.

### MATERIALS AND METHODS

### Example 1-TFC-NF from PIP and TMC Un-Activated in DCM

In various trials, about 15 g vacuum-dried ANF was combined with 5 to 15 g of milled potassium hydroxide and the mixture dispersed in 500 mL DMSO using mechanical stirring under a nitrogen atmosphere. The dispersion was stirred at room temperature for 2 to 4 weeks. In various trials, aqueous solutions of PIP were prepared by dissolving 0.2 to 1.4 g of PIP in 2 L of deionized water. In various trials TMC in DCM solutions were prepared by dissolving 0.5 to 5 g TMC in 500 mL DCM.

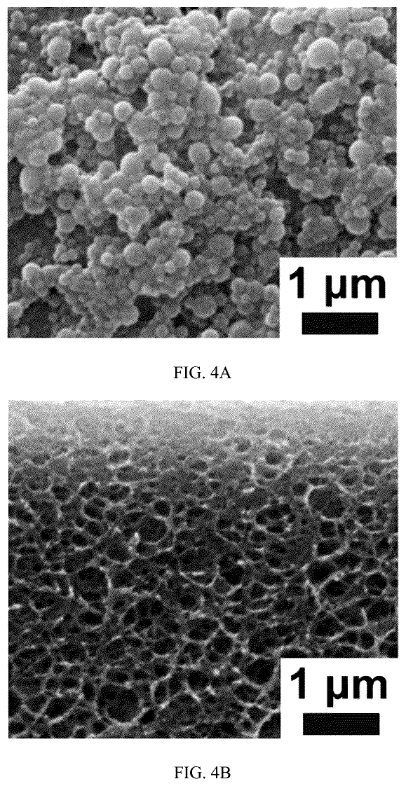

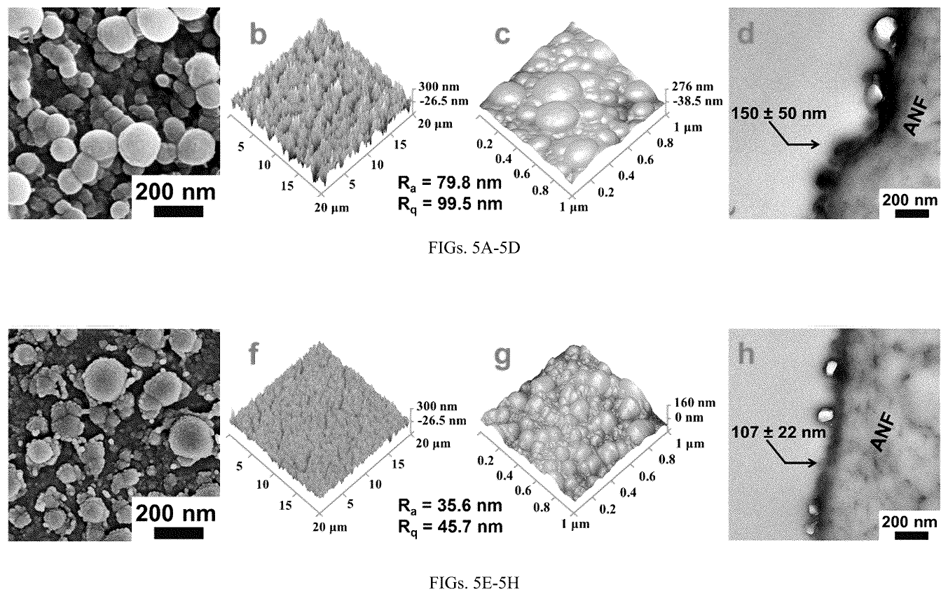

The ANF dispersion was cast onto a customized steel plate, where a doctor blade was set to provide a thickness of 150˜250 μm or using an automatic film applicator (Elcometer 4340, Elcometer Ltd., UK) set with a fixed traverse speed of 2.64 inch per second. A phase inversion and loading with PIP were conducted simultaneously by submerging the cast mixture into an aqueous bath at a PIP concentration consistent with the amount of ANF for 5 to 60 minutes. The PIP coated ANF was then removed using a non-woven fabric and sandwiched with a second non-woven fabric. After supporting the sandwiched PIP coated ANF, vacuum filtration removed excess PIP solution. Interfacial polymerization ensued upon pouring a TMC in DCM solution, at a complimentary concentration to the PIP absorbed on the ANF with solution contact for a period of 30 to 600 seconds. Drying in air to a critical dryness was carried out in air to arrive at the TFC-NF membrane for testing where SEM images are illustrated in FIGS. 4A and 4B. An SEM image of the TFC-NF surface at higher magnification is shown in FIG. 5A. An atomic force microscopic images are shown in FIGS. 5B and 5C at different magnifications which shows the nature of the fine surface. FIG. 5D shows a transmission electron microscope (TEM) image of the membrane.

### Example 2-TFC-NF from PIP and TMC Activated in DCM

The preparation of a similar TFC-NF membrane was performed with the same protocols as Example 1 with an additional activation step by maintaining contact with DCM after IP for 12 to 36 hours. An SEM image of the TFC-NF surface is shown in FIG. 5E. An atomic force microscopic images are shown in FIGS. 5F and 5G at different magnifications which shows the nature of the fine surface. FIG. 5H shows a transmission electron microscope (TEM) image of the membrane.

### Example 3-TFC-NF from PIP and TMC Un-Activated in TCM

The preparation of a similar TFC-NF membrane was performed with the same protocols as Example 1 except that chloroform (TCM) was used instead of DCM.

### Example 4-TFC-NF from PIP and TMC Un-Activated in TCM

The preparation of a similar TFC-NF membrane was performed with the same protocols as Example 3 except that the aqueous PIP solution was 0.01% to 0.1 w/v.

### Example 5-TFC-NF from PIP and TMC Un-Activated in DCE

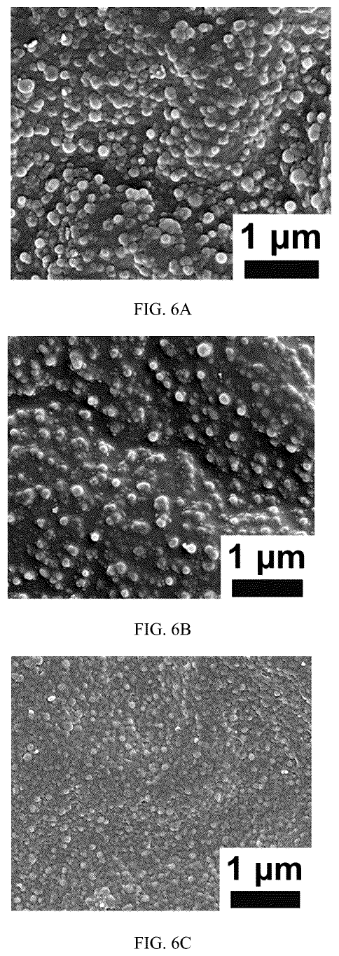

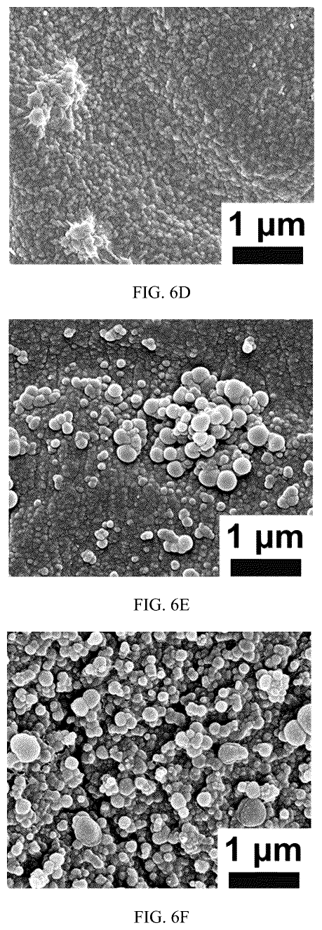

The preparation of a similar TFC-NF membrane was performed with the same protocols as Example 1 except that 1,2-dichloroethane (DCE) was used instead of DCM. An SEM of the prepared membrane is shown in FIG. 6A.

### Example 6-TFC-NF from PIP and TMC Un-Activated in TCE

The preparation of a similar TFC-NF membrane was performed with the same protocols as Example 1 except that 1,1,2-Trichloroethane (TCE) was used instead of DCM. An SEM of the prepared membrane is shown in FIG. 6B.

### Example 7-TFC-NF from PIP and TMC Un-Activated in PhH

The preparation of a similar TFC-NF membrane was performed with the same protocols as Example 1 except that benzene (PhH) was used instead of DCM. An SEM of the prepared membrane is shown in FIG. 6C.

### Example 8-TFC-NF from PIP and TMC Un-Activated in PhF

The preparation of a similar TFC-NF membrane was performed with the same protocols as Example 1 except that fluorobenzene (PhF) was used instead of DCM. An SEM of the prepared membrane is shown in FIG. 6D.

### Example 9-TFC-NF from PIP and TMC Un-Activated in ODCB

The preparation of a similar TFC-NF membrane was performed with the same protocols as Example 1 except that 1,2-Dichlorobenzene (ODCB) was used instead of DCM. An SEM of the prepared membrane is shown in FIG. 6E.

### Example 10-TFC-NF from PIP and TMC Un-Activated in ODFB

The preparation of a similar TFC-NF membrane was performed with the same protocols as Example 1 except that 1,2-difluorobenzene (ODFB) was used instead of DCM. An SEM of the prepared membrane is shown in FIG. 6F.

### Characterization and Performance of the TFC-NF Membranes

Structural characterization of membranes for the optimal trial of the various examples are tabulated below.

TABLE 1
The mean pore radius μₚ, geometric standard deviation
σₚ and molecular weight cutoff for neutral solutes
(MWCO) for TFC-NF membranes of Example 1 and Example 2.

| | μₚ | | MWCO |
|---|---|---|---|
| Membrane | (Å) | σₚ | (Da) |
| Example 1 | 2.893 | 1.726 | 234 |
| Example 2 | 3.285 | 1.634 | 319 |

TABLE 2
Ionized carboxyl density under various solution pH with a unit
of sites nm⁻² for TFC-NF membranes of Example 1 and Example 2.

| | Example 1 | Example 2 |
|---|---|---|
| pH 3.5 | 1.8 ± 0.0 | 1.8 ± 0.0 |
| pH 7 | 43.4 ± 0.3 | 44.1 ± 0.2 |
| pH 10.5 | 70.5 ± 0.3 | 73.5 ± 1.9 |

TABLE 3
The separation performance of membranes for
TFC-NF membranes of Example 1 and Example 2.

| | Example 1 | Example 2 |
|---|---|---|
| R_{Na2SO4} (%) | 99.3 ± 0.1 | 99.2 ± 0.0 |
| R_{MgSO4} (%) | 96.4 ± 1.5 | 92.0 ± 0.8 |
| R_{MgCl2} (%) | 20.3 ± 0.2 | 4.3 ± 0.2 |
| R_{NaCl} (%) | 20.8 ± 0.8 | 20.8 ± 0.7 |
| Water permeance A (L m⁻² h⁻¹ bar⁻¹) | 29.8 ± 1.2 | 52.7 ± 3.2 |
| A/B_{Na2SO4} (bar⁻¹) | 36.9 | 36.2 |
| B_{NaCl}/B_{Na2SO4} | 640.5 | 356 |

where R is the solute rejection, and B is the salt permeability of the membrane

TABLE 4
The separation performance of membranes
of Example 3 and Example 4.

| | Example 3 | Example 4 |
|---|---|---|
| R_{Na2SO4} (%) | 99.4 ± 0.3 | 99.8 ± 0.0 |
| R_{MgSO4} (%) | 97.9 ± 0.6 | 99.4 ± 0.2 |
| R_{MgCl2} (%) | 50.2 ± 6.0 | 62.5 ± 2.3 |
| R_{NaCl} (%) | 22.1 ± 1.6 | 24.0 ± 2.8 |
| Water permeance A (L m⁻² h⁻¹ bar⁻¹) | 41.2 ± 4.2 | 39.5 ± 0.7 |
| A/B_{Na2SO4} (bar⁻¹) | 49.4 | 125 |
| B_{NaCl}/B_{Na2SO4} | 735.1 | 1661.7 |

where R is the solute rejection, and B is the salt permeability of the membrane

TABLE 5
The evaluated mean pore radius μₚ, geometric standard deviation
σₚ and MWCO of membrane Example 3 and Example 4.

| | μₚ | | MWCO |
|---|---|---|---|
| Membrane | (Å) | σₚ | (Da) |
| Example 3 | 3.465 | 1.323 | 338 |
| Example 4 | 3.336 | 1.636 | 321 |

TABLE 6
The evaluated mean pore radius μₚ, geometric standard
deviation σₚ and MWCO of membrane of Examples 5-10.

| | μₚ | | MWCO |
|---|---|---|---|
| Membrane | (Å) | σₚ | (Da) |
| Example 5 | 3.206 | 1.652 | 327 |
| Example 6 | 3.311 | 1.652 | 324 |
| Example 7 | 2.957 | 1.760 | 310 |
| Example 8 | 2.788 | 1.752 | 261 |
| Example 9 | 3.071 | 1.707 | 305 |
| Example 10 | 2.977 | 1.686 | 264 |

TABLE 7
Membrane ionized carboxyl density and surface
zeta potential under pH 5.7 for Examples 5-10.

| | Ionized carboxyl | |
|---|---|---|
| | group density | Zeta potential |
| | sites nm⁻² | mV |
| Example 5 | 17.0 ± 0.4 | 1.8 ± 0.0 |
| Example 6 | 17.7 ± 0.3 | 44.1 ± 0.2 |
| Example 7 | 16.4 ± 0.3 | 73.5 ± 1.9 |
| Example 8 | 12.7 ± 0.2 | 16.4 ± 0.3 |
| Example 9 | 17.6 ± 0.1 | 16.4 ± 0.3 |
| Example 10 | 18.1 ± 0.3 | 16.4 ± 0.3 |

TABLE 8
The separation performance of membranes for Examples 5-10.

| | Example | Example | Example | Example | Example | Example |
|---|---|---|---|---|---|---|
| | 5 | 6 | 7 | 8 | 9 | 10 |
| R_{Na2SO4} (%) | 99.7 ± 0.1 | 99.7 ± 0.0 | 99.7 ± 0.1 | 99.6 ± 0.0 | 99.6 ± 0.1 | 99.8 ± 0.0 |
| R_{MgSO4} (%) | 99.3 ± 0.1 | 97.7 ± 0.5 | 99.6 ± 0.1 | 99.2 ± 0.1 | 99.1 ± 0.1 | 99.1 ± 0.2 |
| R_{MgCl2} (%) | 51.1 ± 1.5 | 31.5 ± 1.8 | 82.8 ± 0.7 | 83.7 ± 0.3 | 70.1 ± 0.5 | 67.4 ± 0.7 |
| R_{NaCl} (%) | 25.2 ± 1.0 | 18.8 ± 1.3 | 31.1 ± 4.1 | 29.0 ± 4.5 | 29.4 ± 1.5 | 27.8 ± 1.6 |
| Water permeance A | 14.0 ± 1.9 | 18.9 ± 3.0 | 14.6 ± 2.9 | 14.0 ± 2.8 | 18.3 ± 1.3 | 21.0 ± 0.6 |
| (L m⁻² h⁻¹ bar⁻¹) | | | | | | |
| A/B_{Na2SO4} (bar⁻¹) | 94.6 | 72.9 | 87.3 | 57.0 | 56.2 | 150.2 |
| B_{NaCl}/B_{Na2SO4} | 1212 | 2070 | 960 | 655 | 595 | 1903 |

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A method for preparing a thin film composite nanofiltration (TFC-NF) membrane comprising:
providing a dispersion comprising aramid nanofibers (ANFs) in a water miscible polar organic solvent;
forming a thin film comprising the ANFs;
providing an aqueous solution comprising a di- and/or poly-amine;
combining the thin film with the aqueous solution to form an amine absorbed aramid nanofiber film;
providing an organic solution comprising a di-, tri, and/or poly acid chloride in a water immiscible polar organic solvent;
adding the organic solution to the amine absorbed aramid nanofiber film to form a thin film composite (TFC) of a polyamide (PA) on ANFs and an acid chloride depleted organic solution;
removing the depleted organic solution; and
drying the TFC of the PA on ANFs to form the TFC-NF membrane.

2. The method according to claim 1, wherein the water miscible polar organic solvent is selected from dimethylsulfoxide (DMSO), 1-methyl-2-pyrrolidinone (NMP), dimethylformamide (DMF), and combinations thereof.

3. The method according to claim 1, wherein forming a thin film comprises spreading a film of a plate with a doctor blade.

4. The method according to claim 1, wherein forming a thin film is via an automatic film applicator on a plate.

5. The method according to claim 3, wherein the plate is a steel plate or a glass plate.

6. The method according to claim 1, wherein the dispersion further comprises a base.

7. The method according to claim 6, wherein the base is selected from sodium hydroxide, potassium hydroxide, cesium hydroxide, and any combination thereof.

8. The method according to claim 1, wherein the di- and/or poly-amine is selected from piperazine (PIP), ethylenediamine, linear and branched polyethyleneimine, and any combination thereof.

9. The method according to claim 1, wherein the acid chloride is selected from trimesoyl chloride (TMC), isophthaloyl chloride, and any combination thereof.

10. The method according to claim 1, wherein the water immiscible organic solvent is selected from dichloromethane (DCM), chloroform (TCM), 1,2-dichloroethane (DCE), 1,1,2-Trichloroethane (TCE), benzene (PhH), fluorobenzene (PhF), 1,2-dichlorobenzene (ODCB), 1,2-difluorobenzene (ODFB), butyl acetate, iso-butyl acetate, ethyl butanoate, and any combination thereof.

11. The method according to claim 1, further comprising activating the TFC of a PA on ANFs by contacting with the water immiscible organic solvent for at least 12 hours.

12. A thin film composite nanofiltration (TFC-NF) membrane formed by the method according to claim 1, wherein the TFC-NF membrane is characterized by a homogeneous surface morphology comprising a dense nanobubble morphology with a high actual surface area.

13. A method of water purification, comprising passing the water through a thin film composite nanofiltration (TFC-NF) membrane according to claim 12.

14. The method according to claim 4, wherein the plate is a steel plate or a glass plate.
